(19) United States
(12) Patent Application Publication
(10) Pub. No.: US 2014/0199553 A1
(43) Pub. Date: Jul. 17, 2014

(54) LAMINATED PRODUCT PRODUCED BY PLACING ONE LAYER ONTO A SEMI SET PARTIALLY CURED BASE LAYER

(71) Applicant: William Alexander James Sadler, Donvale (AU)

(72) Inventor: William Alexander James Sadler, Donvale (AU)

(21) Appl. No.: 14/234,549

(22) PCT Filed: Jul. 27, 2012
(86) PCT No.: PCT/AU2012/000889

§ 371 Date: Mar. 20, 2014

(30) Foreign Application Priority Data
Jul. 27, 2011 (AU) 2011902985

(51) Int. Cl. B32B 13/00; B28B 19/00; B32B 37/24; B28B 11/14

(52) U.S. Cl. CPC B32B 13/00; B28B 11/14; B28B 19/00; B32B 37/24
USPC 428/446; 156/73.6; 156/73.3

(57) ABSTRACT

A method for producing a laminated product including applying a slab product to at least one surface of a substrate, the method including placing the substrate onto the slab material when the slab product is in a semi set partially cured state, then allowing the laminated product to cure. Preferably the slab is cement based and the substrate is a masonry product, already manufactured and cured, e.g., tiles, mosaics, bench tops. The method may alternatively cast a cementitious slab first, and then when that is partially cured pour the cementitious substrate onto it, then cutting the whole assembly into smaller pieces while the whole assembly is still in a partially cured semi set state.

### FIELD OF THE INVENTION

The present invention relates generally to laminated products and methods of manufacturing same. The present invention is particularly useful for forming laminated products where either the base substrate or the laminate, or both, is a cementitious material.

### BACKGROUND

Presently, the process of manufacturing cementitious products such as tiles and building blocks remains substantially the same as production methods that have been employed for the past 50 years and is still popular throughout the world.

However, over the past twenty years, the production of building material has developed resulting in materials with a greater contemporary appearance in response to the fashion and trends of modern architecture and interior design. As such, where structures include a surface which is visible, it may be desired to place other materials over the surface'of the structure so as to provide a more pleasing or suitable surface. Materials for creating such surfaces over the structure can include natural stone, tiles, rendering, plastering, plasterboard and other slab materials.

Presently, commercially available cementitious slab products are produced from a mix which typically comprises cement, silica sand, large (or coarse) aggregate pieces, a water reducing admixture and water. The large aggregate pieces are included to make up mass and may vary in size from approximately 3 mm to 10 mm or larger. Stone chips are often used as large aggregate pieces. The water reducing admixture may be a plasticizer based on Polycarboxylatic Ether Polymer.

Autoclaved Aerated Concrete (AAC) or Autoclaved Cellular Concrete (ACC) is used to manufacture many cementitious products such as Hebel blocks, wall panels, floor and roof panels and the like. The precast material is lightweight and provides structure, insulation and fire and mould resistance properties. Construction with said pre-cast blocks is quick and easy since the material can be routed, sanded and cut using conventional carbon steel saws and drills. However, the material is not suitable for the external elements and therefore not considered finished. The material can be coated or have siding materials used to cover the AAC material.

The strength of material used in tile production has increased in relatively recent times, allowing floor and wall tiles to be produced from a single large and thin slab, similar to marble or granite slabs, which can be cut to produce square or rectangular tiles of a desired size.

However, present production methods of cementitious slab products have a number of significant problems.

For example, the processing (cutting, calibrating, arising and/or rectification) of a slab is generally effected by use of diamond cutting tools, such as cutting blades, calibrating tools etc.

When cutting a cured slab, which is a very hard material, the edges of the cut are subject to varying degrees of chipping and rough edges. Further, the slabs and/or tiles are liable to crack or break during the cutting and calibrating process. The stresses can cause chips and breakages, particularly at corners where the cementitious slab is weakest. The chipping, cracking and/or breakages can result in wastage or the need to repair damaged material. This can be both costly and time consuming.

Further, when a building structure constructed from bricks, masonry blocks or other construction materials requires surfacing with another more desirable product, it results in a two-step process which is time-consuming, and often requires people with different skill sets to complete the construction. For example, a bricklayer can construct a wall with a tiler or stone mason being required to tile a surface of the brick wall.

It is an object of the present invention to provide a process and product which at least ameliorates one or more of the above-mentioned disadvantages associated with construction materials.

The reference to any prior art or prior art techniques, in this specification is not, and should not be taken as, an acknowledgement or any suggestion that these references form part of the common general knowledge of persons skilled in the relevant field of technology.

### SUMMARY OF THE INVENTION

In one aspect, the present invention provides a method for producing a laminated product including applying a slab product to at least one surface of a substrate, the method including placing the substrate onto the slab material when the slab product is in a semi-set state and allowing the laminated product to cure.

The substrate can be any material which naturally adheres to the cementitious slab material when the slab is in a semi-set state. In some embodiments, the substrate material is a masonry product that itself has already been manufactured and cured and naturally adheres to the cementitious slab material that is in a semi-set state. In other embodiments, the substrate itself is not cured and is forced onto the semi-set slab material (or applied to the slab in a semi-set state) and the curing process adheres the slab and substrate materials to form the laminated product.

In another aspect, the present invention provides a method for cutting a laminated cementitious product with a vibrating cutting tool when the cementitious material is in a semi-set state.

In one embodiment, the substrate is placed onto the slab material when in a semi-set state and the material is cut around the substrate.

In one embodiment, the slab material is cut in line with the edge(s) of the substrate.

In another embodiment, the slab material is cut in a semi-set state and the substrate is placed onto the cut slab material.

In another embodiment, the surface of the slab material to which a substrate is to be adhered is treated with a retardant material to delay the curing of the surface whilst allowing the remaining material in the slab to cure. In this embodiment, the adhesion surface is retained moist such that a substrate my be applied some time after pouring the slab thereby enabling the slab material to partially cure and gain structural integrity whilst preventing the adhesion surface from curing at the same rate as the remainder of the slab material. The delayed curing of the adhesion surface ensures a good bond with the substrate even though the remainder of the slab material has partially cured and this process is particularly useful in instances where the substrate is applied to the slab product. If a substrate is applied too soon after pouring, the substrate could squeeze and deform the slab under the weight of the substrate. However, allowing partial curing of the slab whilst retaining the adhesion surface moist addresses this problem. In an embodiment, the retardant is a chemical composition that is evenly sprayed onto the adhesion surface of a slab shortly after the slab has been poured and naturally dissolves or degrades over time thus not interfering with the adhesion of the adhesion surface of the slab to the applied substrate. The chemical composition may be an adhesive sprayed or applied that optimizes bonding between surfaces.

In another embodiment, the substrate is placed onto cut slab material such that the edges of the substrate are in line with the corresponding edges of the cut slab material.

In a further embodiment, the substrate is placed onto the cut slab material such that the substrate is offset relative to the cut slab material to provide a recessed edge on a first side and an overhanging edge on a second opposing side.

In one embodiment, the slab material is cementitious and the constituent materials include cement and other materials with the combined mixture having particle sizes sufficiently small to allow the material to be cut with a vibrating cutting tool. The cementitious material is poured into a mould or casting table and then allowed to cure to a semi-set state that, when sufficiently cured, allows the cutting tool to separate the slab into smaller pieces (or remove material from the slab) without the material deforming either during or subsequent to the operation of the cutting tool.

In one embodiment the preselected frequency of the vibrating cutting tool is an ultrasonic frequency. The frequency of vibration may be adjusted or selected to best suit the constituent material of the slab.

In one embodiment, the cutting tool is a straight blade that is mounted on a robotic arm and is manoeuvred under the direction of a control system operating the arm. Whilst the blade will typically be positioned substantially vertically for cutting a slab that is disposed substantially horizontally, it is not necessary for such a geometrical arrangement to exist between the blade and the slab. For example, the slab may be disposed at an angle and further, the blade may be angled with respect to the slab such that it can cut chamfers or create bevelled edges.

In another embodiment, the cutting tool is a curved blade that can be used to create desired profiles.

The cutting tool is not necessarily limited to a blade and in other embodiments, the cutting tool includes a grating device or a reciprocating cutting tool for removing a fine layer of material.

Profiles may serve a functional purpose or simply provide an aesthetic effect. In this regard, there is an increasing market demand for new and interesting shapes of floor and wall tiles. In response to the demand for innovative products, high resolution digital printing techniques to generate flexographic and/or photopolymer plates have been used to add complex surface decoration to tiles and the present invention is particularly suited to satisfying the demand for an aesthetic difference to the predominantly available range of square and/or rectangular shaped tiles. In one embodiment, the mould into which the slab material mix is poured is pattered to create a patterned and/or textured surface on the laminated product.

In an embodiment, the slab material is cementitious and the constituent materials do not include large aggregates that would otherwise impede the passage of the cutting tool as it passes through the material, which could otherwise cause tearing or rippling of the material. The cementitious material is poured into a mould and then allowed to cure to a semi-set state that is a state sufficiently cured to allow the cutting tool to separate the slab into smaller pieces (or remove material form the slab) without the state of the material deforming subsequent to the operation of the cutting tool.

In another embodiment, the mould includes a sacrificial layer of material to absorb cutting damage that could be imparted by the cutting tool to the mould. The sacrificial layer of material (mould lining) may be applied prior to pouring (or pressing) the material into the mould and may be removed subsequent to the cutting process when de-moulding occurs. The mould lining reduces wear on the mould surface, reduces daily cleaning and/or maintenance requirements therefore should reduce wastage and/or costs and/or improve the quality of the slab products.

In another embodiment the substrate material includes gypsum. In this embodiment, the substrate may further include linerboard. The linerboard may itself be cut with the material in a semi-set state to produce a shape and/or size of liner board that is presently not available according to current production methods.

In another aspect, the present invention provides a method for producing a laminated product, wherein one component of the laminated product is initially a slab of cementitious material including cement and materials with the combined mixture having particle sizes sufficiently small to allow the material to be cut with a vibrating cutting tool, pouring the cementitious material into a mould and allowing to cure to a semi-set state and, when sufficiently cured, cutting the material with the vibrating tool to separate the slab of material into smaller pieces (or remove material from the slab) without the material deforming either during or subsequent to the operation of the cutting tool, and applying a substrate to the semi-set slab and allowing to fully cure thus forming the laminated product.

In another aspect, the present invention provides a method for producing a laminated product wherein a first component of the laminated product is initially a slab of cementitious material including cement and materials with the combined mixture having particle sizes sufficiently small to allow the material to be cut with a vibrating cutting tool; pouring the cementitious material into a mould subsequently applying a substrate material, thus forming a second component of the laminated product, onto the slab material, the substrate material also including cement and materials being a combined mixture with particles sizes sufficiently small to allow the substrate material to also be cut with a vibrating cutting tool; pouring the cementitious substrate material onto the slab material; allowing the slab and substrate materials to cure to a semi-set state and cutting the laminate slab product into smaller pieces without the laminate product deforming either during or subsequent to the operation of the cutting tool.

In one embodiment, relatively large laminated slabs of cementitious material are formed with a slab providing a relatively thin laminate to a larger slab in the form of the substrate. Increasingly, large pre-formed (or pre-cast) slabs of cement based material are being used for the construction of buildings where the pre-cast slab is positioned by a crane or other suitable lifting device. Forming a wall with large pre-cast slabs is quick and efficient and reduces building costs as compared with building with smaller components such as bricks. However, the large pre-cast slabs have an unsightly appearance and in, many instances, require the application of a surface treatment such as rendering or painting to improve the appearance. Large slabs with a laminate formed during the manufacturing process addresses the requirement to render a pre-cast slab with an appropriate surface material to improve the resulting appearance.

In another embodiment involving the manufacture of large laminated slabs, the cutting tool is used to “cut” the surface of one or both of the slabs (ie laminate and/or substrate) thus providing a strip or section of the slab where cracking will occur in the event that the slab is subject to stress that will cause cracking or a surface fracture of a slab.

In another aspect, the present invention provides a laminated cementitious product according to one or more of the methods of the present invention described herein.

It will be recognised by skilled readers that the term “cure” is interchangeable with the term “set”. It will also be recognized that the term “semi-set” has a substantially similar meaning to “semi-plastic” or “semi-hardened”.

### BRIEF DESCRIPTION OF THE DRAWINGS

FIG. 1 is a perspective view illustrating an embodiment of a cutting process in accordance with the invention;

FIG. 2A is a perspective view of a slab of material with an array of various shaped cuts rendering an array of different shaped tiles when de-moulding occurs. In this Figure a substrate is place onto a corresponding cut slab product;

FIG. 2B is a perspective view of a slab of material illustrating the substrate being placed onto the cut slab product such that it is offset relative to the slab product;

FIG. 3 is a perspective of a slab of material illustrating the substrate being placed onto the slab material prior to cutting of the slab material;

FIG. 4 is a perspective view of a slab of material which has been produced using a patterned mould;

FIG. 5 is a perspective view of laminated cementitious products made using different substrates;

FIGS. 6A and 6B are perspective views, of laminated cementitious products having a slab products applied to more that one surface of the substrate; and

FIG. 7 is a perspective view of a laminated cementitious product illustrating the substrate made of an aerated cementitious material.

### DETAILED DESCRIPTION OF EMBODIMENTS OF THE INVENTION

It is noted that all of the discussion below, regardless of the particular embodiment being described, is exemplary in nature, rather than limiting.

The present invention is relevant to the manufacture of laminated cementitious products which may be used as building blocks or bricks, tiles (internal, external, floor and wall; conventional and alternative type tiles); wall, floor and roof panels (both internally and externally); mosaics (including floor mosaics); kitchen bench tops; kitchen counters, benches and islands; table tops; integrally cast products for tilt-up panels including scott systems; insulation tiles; other slab products for the slab market; furniture; roof tiles or slab and/or tiles for other suitable applications.

According to some embodiments, the substrate can be made of any material which adheres to the cementitious slab material when in a semi-set state.

An example method for producing the slab including cementitious material includes the steps of mixing cement, a fine aggregate material, an ultra fine aggregate material and water. The fine aggregate material and/or the ultra fine aggregate material may be a siliceous material, including sand. Further, the cementitious mix may also include a crushed aggregate material and/or flour, wherein the crushed aggregate material may also be sand.

In order to reduce water content of the cementitious mix, a water reducing plasticizer may be added, which may be a polycarboxylatic ether polymer. The amount of water reducing plasticizer may be between approximately 1% to 5% of the mix by weight of cement. For example, should the cement content of the cementitious mix be 100 kilograms, the amount of water reducing plasticizer may be between approximately 1 kilogram and 5 kilograms. The water to cement ratio, where a water reducing plasticizer is used, may be approximately 0.26.

The ratio of cement to fine aggregate material to ultra fine aggregate material may be 2:2:1. For example, the cementitious mix may contain 100 kilograms of cement, 100 kilograms of fine aggregate material and 50 kilograms of ultra fine aggregate material. Furthermore, in an embodiment where the cementitious mix includes either crushed aggregate material or flour, the ratio of cement to fine aggregate material to ultra fine aggregate material to crushed sand or flour may be 10:10:5:2. For example, the cementitious mix may contain 100 kilograms of cement, 100 kilograms of fine aggregate material, 50 kilograms of ultra fine aggregate material and 20 kilograms of crushed aggregate material or flour.

Of course, the precise ratios of materials in any mix that will produce the best result will depend upon the quality and suitability of the materials, the quality of the polycarboxylate admixture and the efficiency of the mixing apparatus.

In a further embodiment, the cementitious mix may include vinegar and/or ethanol (buffer solution), which is included in order to reduce air content of the cementitious mix. The air content of the cementitious mix may be in the form of air bubbles and it is intended that the vinegar and/or ethanol reduce the air bubble content of the cementitious mix or to allow the air that is present or produced whilst mixing to dissipate during the casting and settling period. The vinegar and/or alcohol to cement ratio may be approximately 0.075.

The material is mixed into a wet consistency. The period of mixing may be approximately (5-10) minutes.

Following mixing of the cementitious mix, the material is then placed in a mould for producing a cementitious slab. Moulds may be of varying shapes and sizes and may be made from various materials including aluminium, steel, timber, plastic and/or acrylic. In one embodiment, the mould is made of glass.

As the cutting equipment may damage the surface of a mould, a sacrificial layer of material (or mould liner) may be used with the mould to prevent, or at least reduce damage to the mould. The mould liner may be discarded and replaced after the de-moulding process, and may be formed from plastic, waxed paper or any material suitable for preventing damage to the mould surface that could otherwise occur when a cutting tool is used to cut the slab.

In addition to preventing damage to the mould by the cutting tool, the mould liner also protects the mould surface from the material that is poured in to the mould. In this regard, the mould liner avoids the requirement to clean the surface of the mould after slab products are de-moulded. Obviating the need to clean the mould surface avoids the time and cost that would otherwise be incurred for this task. Also, avoiding damage and any deposit of material on the mould surface ensures consistency in the appearance of slab products manufactured from the mould.

When in the mould, the cementitious mix is allowed to self-level. Self-levelling may take approximately 2 minutes to 6 minutes in duration as air and air bubbles escape from the cementitious mix. Approximately 90% to 95% or greater of air is expected to escape from the mix during the self-levelling process without intervention.

A further reduction in air and air bubbles may be achieved by gently vibrating the mould containing the cementitious mix although this is generally unnecessary). A cementitious mix may be vibrated until air and air bubbles substantially no longer appear to be coming to the surface of the cementitious mix. In this regard, the gentle vibration may be of approximately 3 to 10 seconds duration. In any event, the extent to which the mixture requires vibration is significantly reduced as compared with prior methods of producing a slab of cementitious material. Reducing the extent to which vibration is required substantially reduces a significant variable in the production process. Of course, reduction of any variable in a production process has the effect of improving the quality and reproducibility of products from the process.

Following levelling and vibrating of the cementitious mix, it is allowed to set until it is in a substantially semi-set (or substantially semi-hardened) state. When in a semi-set state, the cementitious slab may be cut in to tiles or other desired products. In a semi-set state, the cementitious material may be cut with a cutting tool such as a knife or sharp tool vibrated at a preselected frequency.

The preselected frequency may be an ultrasonic frequency, which may be in the range of 20 kHz to 40 kHz. The ultrasonic cutting tool may be a hand held type or may be incorporated into automated machinery, such as computer controlled automated cutting machinery.

Using a blade vibrating at an ultrasonic frequency should result in very little or substantially no cementitious material sticking to the blade when cutting. This should result in the blade not needing to be cleaned and should also result in little or substantially no cementitious material being removed from the slab during the cutting process. Of course, this also assists to ensure that the slab material is neither torn nor rippled, or otherwise deformed, during the cutting process other than providing a smooth separation.

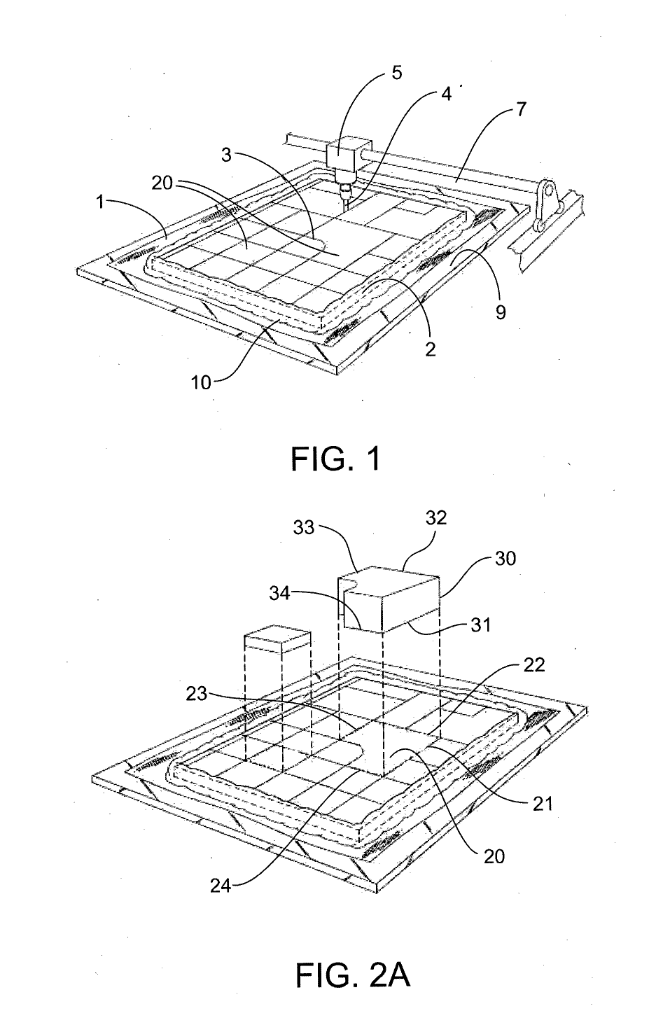

As illustrated in FIG. 1, a cementitious slab 2 may be formed in a mould 1 and can be cut with a cutting tool such as a blade 4, which is fitted to a cutting device 5. The cutting device 5 may be an ultrasonic cutting device.

FIG. 1 also illustrates various other components of the mould including the support 7, a layer of material 9 that forms a mould lining and a mould retaining wall 10. The support 7 should provide a surface to the poured material that is acceptable for an “off-form” mould. In the embodiment of FIG. 1, the support 7 is a sheet of glass that presents a very uniform surface to the poured material.

In order to protect the support 7 from the cutting tool 4, a mould lining 9 is applied to the surface of the support 7. In the embodiment of FIG. 1, the mould lining 9 is applied to the support 7 with a tool to ensure that any air between the mould lining 9 and the support 7 is substantially removed.

Subsequent to applying the lining 9, the retaining wall 10 is formed. In the embodiment of FIG. 1, the retaining wall 10 is formed from an acrylic material that is malleable and quick drying. Once solidified, the wall 10 remains relatively soft and malleable such that it may be easily removed.

The ultrasonic cutting tool may be a thin blade, which is capable of cutting cementitious material in a semi-set state. Further, cutting of the material may occur at approximately 0.4-1 metre per second.

The blade 4 cuts the cementitious slab 2 in a desired shape. In the exemplary embodiment shown in FIG. 1, the cut 3 has an irregular shape, which is a curved shape. As the slab material 2 is cut while in a semi-set state, the cut 3) may be of many different shapes, including curved lines and sharp corners.

The cementitious material cures into a substantially semi-set state following self-levelling and/or vibration. This part of the curing process may be approximately 30 minutes to 1 hour in an ambient temperature of approximately 21 degrees Celsius. A higher ambient temperature may accelerate the curing time. It is important to understand that cutting of the cementitious slab may occur at any time after the placement of the cementitious material into a mould, however, the cementitious material should be levelled, air and/or air bubbles allowed to be emitted and/or removed, and the cementitious material sufficiently cured so as to be in a semi-set state.

The cementitious material may be assessed for suitability for cutting by applying the cutter to the cementitious material and observing that when the material is cut it does not deform and/or meld back together over or around the cut.

It will be recognised that, as the cementitious slab is cut whilst in a semi-set state, there is substantially reduced stress on the cementitious material as compared with previous methods of cutting which involves the use of a diamond tipped saw blade cutting the material in a hardened state.

As a result of the reduced stress on the cementitious material, chipping and breaking of the cementitious slab should be eliminated or at least substantially reduced. Further, substantially no cementitious material adheres to the cutting tool during the cutting process of the present invention.

The cementitious slab may be cut into tiles having a range of sizes and shapes. The shapes may include curved and rounded shapes and the tiles may also be produced with sharp corners. According to some embodiments, the slab is cut to have a complimentary shape to a substrate to which the cut slab is to be applied.

It will be appreciated by those skilled in the relevant field of technology that cutting a slab in a semi-set state with a vibrating cutting tool affords a significantly greater degree of flexibility as compared with current slab product manufacturing methods. For example, with reference to FIG. 1, a slab is illustrated depicting various shaped slab products 20. In this regard, the individual slab products have various shapes including circular, square and rectangular. Each of these products may be cut from the slab with an inclined or straight wall and the degree of flexibility afforded by the present invention is clearly demonstrated as a single slab may be cut to generate a range of different shaped slab products depending upon the particular manufacturing requirements at any point in time.

Further, the slab material 2 illustrated in FIG. 1 includes slab products 20 with a shape and configuration that are very difficult to manufacture according to present production methods or at least, extremely difficult to manufacture without a substantial amount of waste. For example, diamond shaped tiles are particularly rare in view of the difficulty associated with cutting a diamond shaped tile from a slab with a diamond tipped saw blade. In this regard, it is very difficult to produce a diamond shaped tile according to present production methods as the physical stress imparted to a tile during the cutting process with a diamond tipped cutting blade generally results in damage in the form of chipping in the region of the diamond shaped tile at the point where the intersection of the walls of the tile define an acute angle.

For this reason, the present approach to manufacturing tiles with curved shapes and/or pointed portions is to use a high pressure jet of water to cut the specific shape desired from a slab. However, this approach has a number of disadvantages that render it commercially infeasible for producing slab products such as tiles. Generally, this approach to producing a tile is only used for a special requirement or a one only design where a premium price is expected.

As can be seen from FIG. 1, the degree of flexibility available with respect to cutting particular shaped slab products from a slab according to this embodiment of the invention is only limited by the ability to control the position and passage of the vibrating cutting tool. In an embodiment, the vibrating cutting tool is controlled by a robotic arm or a CNC machine and for any particular production requirement it is only necessary to select the appropriate control program that defines the shape and/or configuration of slab products to be cut from the slab.

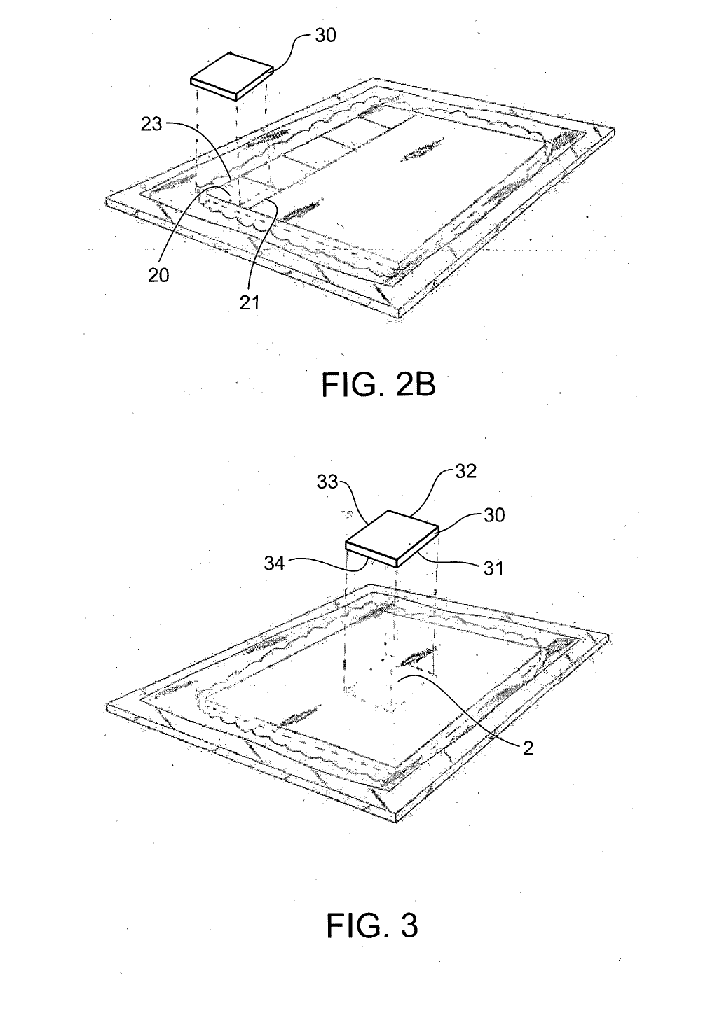

With reference to FIG. 2A, once the cementitious slab material has been cut in a substantially semi-set state, a substrate 30 can be placed onto a corresponding slab product 20 which is complimentary in shape. In the exemplary embodiment shown in FIG. 2, substrate 30 is placed directly onto the slab material such that the edges 31, 32, 33, 34 of the substrate 30 are substantially in line with edges 21, 22, 23, 24 of the slab product 20.

In a further embodiment illustrated in FIG. 2B, the substrate 30 is placed, onto the cementitious slab product 20 such that the substrate (30) is offset relative to the slab product 20 to provide a recessed edge on a first side 23 of the slab product 20 and an overhanging edge on a second 21 opposing side of the slab product 20 when the product is demoulded. The embodiment shown in FIG. 2B is useful for applications where the smooth finish of a slabbed surface is desired. Generally, constructions formed by brickwork or Hebel blocks or the like require the application of mortar or another suitable substance in between adjacent bricks or blocks to construct a wall or structure. The off-set positioning of the slab product 20 enables the mortar between adjacent brickwork to be concealed by the overhanging edge of the slab product 20 which will be positioned over the join. It is envisaged that a waterproof sealant or the like can be applied along the adjoining edge of adjacent slab products if necessary.

With reference to FIG. 3, the substrate (30) is illustrated once again being placed onto the slab product 20. However, FIG. 3 illustrates the substrate 30 being placed onto the cementitious slab material 2, when the material is in a semi-set state prior to cutting of the slab material 2. Once the substrate has been placed onto the slab material the cutting tool can be used to cut around the substrate while the slab material is in a substantially semi-set state. In the exemplary embodiment in FIG. 3, the slab material is cut adjacent the edges 31, 32, 33, 34 of the substrate 30 to be substantially in line with the substrate edges. However, it is envisaged that the slab material can be cut to various different shapes and sizes around the substrate to suit different applications.

Once the slab has cured to a semi-set state the vibrating cutting tool can be used to remove the retaining wall formed by the malleable acrylic material to expose the edge of the slab material in order to allow access of a vibrating cutting tool to generate a desired edge profile. In an embodiment of the invention effecting this particular method, at the time of cutting and trimming the mould retaining wall and any excess material to form an edge of a slab product, the material that is desired to be removed may be removed either during or subsequent to the cutting process that separates the unwanted material from the slab. Removal of slab material may be effected by the robotic arm that manoeuvres the cutting device and the cutting tool.

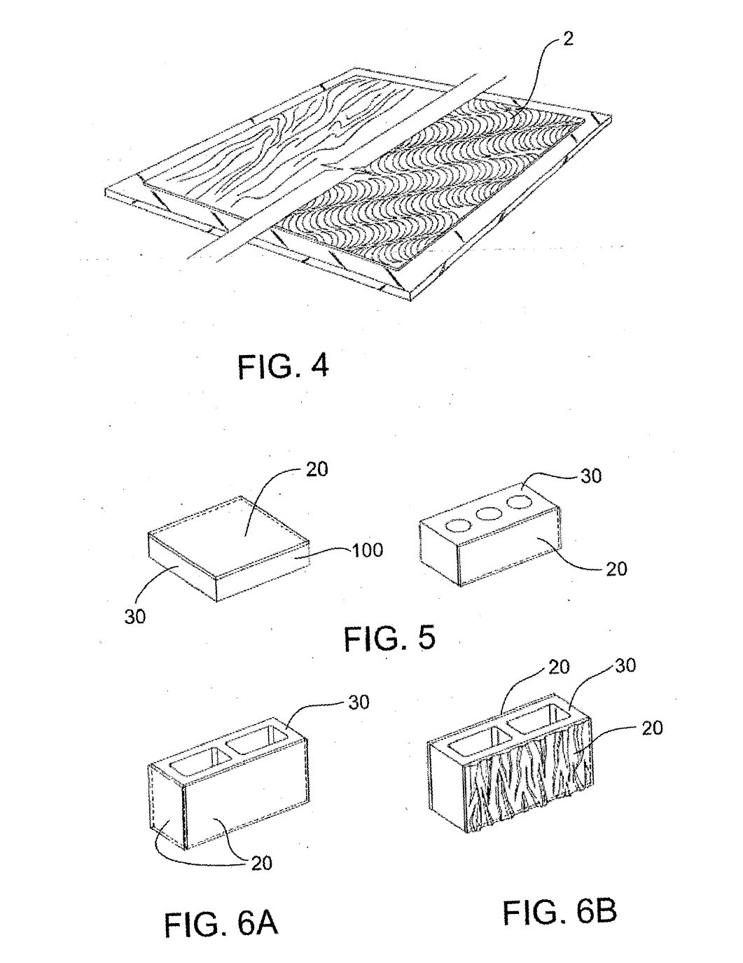

In other embodiments of the invention, the mould has a patterned surface such that once a slab is poured and the initial curing process commences, the top surface of the poured slab is shaped to render the top surface of the poured slab acceptable for presentation as the top surface of the laminated product. In this regard, as illustrated in FIG. 4, the top surface of the de-moulded slab material may be patterned and/or textured to render a suitable surface for a decorative laminated product. Accordingly, it is possible to manufacture laminated products having an unlimited possibility of decorative surfaces including, but not limited to, rendered, wave or swirl surfaces or the like whilst the underlying substrate provides the necessary structural and/or insulating properties that may be required for a particular construction.

Cutting a cementitious slab whilst in a semi-set state does not require the use of expensive cutting equipment, such as diamond tools, and reduces cutting time. Also, the amount of water required for cutting is substantially reduced or may be eliminated altogether. This has a further advantage in that little or no effluence is produced, which previously required expensive treatment and/or disposal.

Cutting a cementitious slab whilst in a substantially semi-set state consumes significantly less energy as compared with prior cutting methods. Many of the above-mentioned advantages may also lead to reduced production costs.

The cementitious slab may be poured to create one component of a laminate product with thicknesses of between approximately 3 mm to 6 mm for application to a substrate. This may create possibilities for new and innovative products.

Furthermore, as a result of there being little or no stress caused to the product during (the cutting) process the material may be substantially stronger. In turn, this may result in fewer problems, such as broken corners etc, during installation of the product.

Moreover, as no large aggregate pieces are used in producing the cementitious material, there may be a reduction in post-installation problems associated with the slow development of cracks (including hair-line cracks).

The fine and/or ultra fine materials may include limestone, granite or marble. A cementitious mix may include a combination of any or all of these materials or other siliceous materials.

The slab product may also be assessed and/or calibrated for consistency of thickness prior to application to a substrate. Any areas of the cementitious slab which are thicker (higher) than desired may be removed. Removal may be effected by a cheese grater type device acting as the cutting tool. However, it will be recognised that any requirement for assessing and/or calibrating the thickness of the cementitious slab and/or removing material from thicker areas of the slab should be substantially minimised or eliminated due to the method of production of the slab according to the present invention. Further, assessing and/or removing cementitious material occurs whilst the cementitious slab is in a semi-hardened (semi-set) state thereby reducing the stress to which the product is subjected as compared with a hardened product.

Following application of a slab product to a substrate, the laminated product is stored for approximately 20 to 24 hours, which allows for further hardening of the products and enables the slab product to adhere to the substrate as a laminate. The laminated cementitious products are hardened such that they may be removed from the mould. FIG. 5 shows different embodiments of the laminated cementitious product 100 using different substrates 30 for application of the laminate slab product 20, once they have been removed from the mould ready for use.

Referring now to FIG. 6A, the substrate 30 can be masonry block which is laminated on one or more sides. In FIG. 6A, the laminate 20 is on a front and side surface of the masonry block 30. Such an embodiment would be useful for providing a corner block for a wall. In FIG. 6B, the laminate 20 is on a front and back surface of the masonry block 30. Such an embodiment would be useful in constructing a dividing wall where both the front and back surfaces of the masonry block will be visible. FIG. 6B also illustrates a patterned laminate surface on the front surface of the masonry block which has been produced by pouring the cementitious material for the slab product into a patterned mould.

In another aspect, the present invention provides a method for producing a substrate, wherein the substrate is cementitious and the constituent materials include cement and other materials with the combined mixture having particle sizes sufficiently small to allow the material to be cut with a vibrating cutting tool. A chemical additive is added to the mixture to aerate the mixture. The cementitious material of the substrate is then poured onto the cementitious slab product without an aerating additive which has been poured into a mould and allowed to cure to a semi-set state. When both layers are sufficiently cured, the cutting tool can separate the slab into smaller pieces (or remove material from the slab) without the material deforming either during or subsequent to the operation of the cutting tool, as previously described herein.

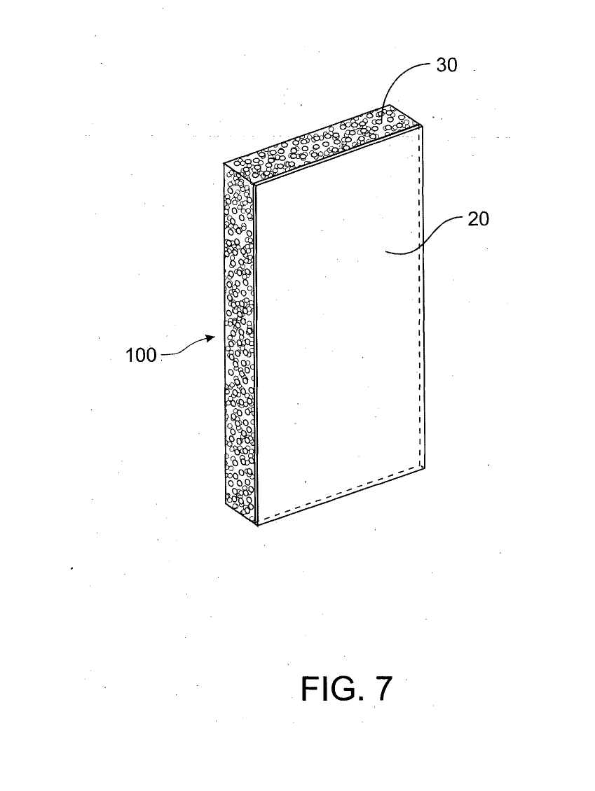

Referring to FIG. 7, the addition of the aerating additive to the substrate 30 creates a laminated product 100 that is very strong and lightweight when compared to a cementitious slab product made of uniform material.

In further embodiments of the present invention, it is envisaged that other additives such as nano particles can be added to the slab product provide a laminate for a substrate which is self-cleaning. Such a product would be useful as a roof tile, providing a laminated roof tile which can be coloured white to reflect heat without having the usual problem of moss growing on the tile.

The present invention embodies various advantages and in particular, provides a laminate of slab material which can be applied to at least one surface of the substrate to render the substrate of greater value particularly where the aesthetic appearance of the substrate is improved without requiring a subsequent and relatively expensive additional process such as rendering or painting.

For example, a Hebel block is a very light construction material. However, it cannot be used for external walls without additional rendering. Laminating Hebel blocks using the method of the present invention enables the Hebel block to be used for an external wall without any additional rendering. The laminated product of the present invention can be used for a wider range of applications without the need for multiple job skills and additional materials and time for construction.

In addition to Hebel blocks, standard masonry blocks can also be improved with a laminate according to the present invention. In this regard, consumers are sometimes reluctant to accept the use of standard masonry products as they are considered to have an unsatisfactory appearance. The same applies to standard masonry bricks such as house bricks and the present invention enables manufacturers to “value add” to their existing products by adding a relatively inexpensive laminate.

The cutting of slab material in a semi-set state avoids the need to allow the slab to harden to a sufficient extent to withstand the stress and impact of cutting the slab with a diamond tipped blade. This has the combined advantages of avoiding the requirement to interrupt the processing of the slab between pouring and cutting and obviates the need for expensive mixing and calibrating/cutting equipment that is normally used in present day manufacturing processes.

Further, by reducing, or virtually eliminating, the amount of material removed from the slab during the cutting process, the manufacturing process avoids any need to use water to capture and carry the excess material away from the cutting surface. This avoids any requirement for a water filtration plant and the on-going maintenance that is usually required for such a system.

Obviating the need for large and heavy equipment, or the need for water drainage and treatment systems, avoids the need to manufacture slab products in a purpose built facility. In contrast, manufacturing slab products in accordance with the present invention may be performed in any facility capable of housing the necessary equipment to effect cutting of slab material in a semi-set state. In this regard, the electrical power consumption to operate such equipment is substantially less than present requirements. Further, by enabling the cutting process to be effected shortly after the pouring process avoids the manually intensive handling associated with interim storage of slabs for curing and also avoids the need to store slabs until such time as they may be cut.

In embodiments of the invention, substrates forming a laminated product with a cementitious component include polystyrene, cement sheeting, plasterboard, fibreglass based material, timber and various wood based products. In addition to altering the appearance of the substrate material, the cementitious laminate can also improve the physical properties of the substrate material. For example, a cementitious laminate can act as a water barrier for a Hebel block or can provide a structurally solid surface to a block of polystyrene that may otherwise be appropriate for its sound and thermal insulating properties.

In an embodiment of the invention, a protective layer is applied to at least one surface of the slab product prior to pouring cementitious mix into a mould and retaining the protective layer in place. The protective layer is applied to a surface of the mould prior to pouring material for the slab product and may be applied to the surface of the mould with a device to reduce the likelihood of air being entrapped between the mould surface and the protective layer.

In another embodiment of the invention, subsequent to cutting of the slab product, the protective layer remains attached to the slab product and the overhanging edges of the protective layer are wrapped around one or more sides of the laminated product, the protective layer remaining in place until such time as the slab product is substantially cured.

In this regard, retaining a protective layer in place until such time as the slab product has substantially cured assists to reduce the effect of efflorescence that may occur that discolours the surface of cementitious products and in this instance, the component of the laminated product.

In another embodiment of the invention, the laminated product is inserted into a sealable container whereafter substantially all of the air is evacuated from the container and the container is sealed prior to the slab product becoming fully cured. In other embodiments, as opposed to evacuating substantially all of the air sealing the container, the air in the sealable container is replaced with a gas. In some embodiments, the gas is carbon dioxide and in one particular embodiment an arrangement allows carbon dioxide to enter the sealable container subsequent to the evacuation of air. As a result of the evacuation of air, the carbon dioxide is effectively drawn into the sealable container.

In other embodiments, a substance such as sodium metasilicate or potassium metasilicate is applied to the surface of the semi-set slab product prior to packaging or during the packaging process.

The present invention allows relatively thin slab product (e.g. 4 mm to 6 mm) to be poured and form a component of the laminated product. This allows material such as nano titanium dioxide, to be added to the slab mixture in sufficient quantities such that the external surface of the slab will display desired properties. For example, nano titanium dioxide is a photocatalytic agent that is presently added to paint such that painted surfaces display the desired properties of the photocatalytic agent, namely, the breakdown of airborne pollutants and removal of same from the atmosphere. However, nano titanium dioxide is relatively expensive and it is presently only used in materials that are applied to surfaces in a thin layer. This enables the surface to embody the desired property of the photocatalytic agent at a reasonable cost.

Cementitious slabs are generally manufactured with a significantly greater thickness to provide the required strength but as a result, adding sufficient quantities of expensive material such as a photocatalytic agent is commercially infeasible as the amount required in the slab to render an outer surface with the desired properties results in an excessive cost in the manufacture of slab products. Further, the arrangement of a laminated product with only a relatively thin outer slab product including the photocatalytic agent, enables the aesthetic integrity of the slab product to be retained whilst also embodying the desirable properties of a photocatalytic agent whereas, according to present arrangements, it is necessary to paint or clad a structural member or material to obtain a surface with a photocatalytic agent. The inclusion of the photocatalytic agent in the slab product also improves the longevity of the agent as a slab product will last substantially longer than paint or plastic cladding.

While certain exemplary embodiments have been described, it is to be understood that such embodiments are merely illustrative of and not restrictive on the invention, and that this invention is not limited to the specific constructions and arrangements described since various other changes, combinations, omissions, modifications and substitutions, in addition to those set forth in the above paragraphs, are possible. Those skilled in the art will appreciate that various adaptations and modifications of the described embodiments can be configured without departing from the scope and spirit of the invention. Therefore, it is to be understood that, within the scope of the appended claims, the invention may be practiced other than as specifically described herein.

1. A method for producing a laminated product including applying a slab product to at least one surface of a substrate, the method including:
placing the substrate onto the slab material when the slab product is in a semi-set state;
cutting the slab product to a desired shape or configuration with a vibrating cutting tool when the slab product is in a semi-set state; and
allowing the laminated product to cure.

2. A method according to claim 1, wherein the substrate includes any material which adheres to the slab product when the slab product is in a semi-set state.

3. A method according to claim 1, wherein the slab product is a cementitious slab.

4. A method according to claim 1, wherein the substrate is a masonry product.

5. A method according to claim 4, wherein the masonry product has already been manufactured and cured and naturally adheres to the slab product material when the slab material is in a semi-set state.

6. A method according to claim 1, wherein the substrate is a curable product and has yet to fully cure and subsequent to the slab product being applied to the at least one surface of the substrate, the curing process adheres the slab product and substrate materials to form a laminated product.

7. A method according to claim 6, wherein the substrate is placed onto the slab material when the slab product is in a semi-set state and the slab product is cut around the substrate.

8. A method according to claim 7, wherein the slab product is cut in line with the edges of the substrate.

9. A method according to claim 7, wherein the slab product is cut in a semi-set state and the substrate is placed onto the previously cut slab product.

10. A method according to claim 1, wherein the surface of the slab product to which a substrate is to be applied, namely, the adhesion surface, is treated with a retardant substance to delay the curing of the adhesion surface of the slab product while allowing the remaining material in the slab product to cure.

11. A method according to claim 10, wherein the adhesion surface is retained moist such that a substrate may be applied at a delayed time after the pouring of the slab product thereby enabling the slab product to partially cure and gain structural integrity while the adhesion surface is prevented from curing at the same rate as the remainder of the slab product.

12. A method according to either claim 10, wherein the retardant substance is a substance that is evenly sprayed onto the adhesion surface of a slab product shortly after the slab is poured and where the retardant substance naturally dissolves or degrades over time thus not interfering with the adhesion of the adhesion surface of the slab product to the applied substrate.

13. A method according to claim 10, wherein the retardant substance is an adhesive.

14. A method according to claim 1, wherein the substrate is placed onto a slab product in a semi-set state and the slab product is cut with a vibrating cutting tool such that the edges of the substrate are in line of the corresponding edges of the slab product.

15. A method according to claim 1, wherein the substrate is placed on to a slab product such that the substrate is offset relative to the slab product to provide a recessed edge on a first side and an over-hanging edge on a second opposing side of the substrate.

16. A method according to claim 1, wherein the slab product is cut with a vibrating tool when the slab product is in a semi-set state and the cutting tool is vibrated at an ultrasonic frequency.

17. A method according to claim 1, wherein the slab product is cut with a vibrating cutting tool wherein the frequency of vibration of the cutting tool is adjusted based on the constituent material of the slab product.

18. A method according to claim 1, wherein the slab product is poured into a mould and allowed to cure to a semi-set state wherein the mould includes at least one contoured or textured surface such that the slab product when removed from the mould exhibits the contoured or textured surface as impressed by the contoured or textured surface of the mould.

19. A method for producing a laminated product wherein a first component of the laminated product is initially a poured slab of cementitious material including cement and materials with the combined mixture having particle sizes sufficiently small to allow the material to be cut with a vibrating cutting tool, comprising:
pouring the cementitious material into a mold;
subsequently applying a substrate once the poured cementitious material achieves a semi-set state, the applied substrate material forming a second component of the laminated product, the substrate material also including cement and materials with particle sizes sufficiently small to allow the substrate material to also be cut with a vibrating cutting tool;
pouring the cementitious substrate material onto the slab material, allowing both the slab and substrate materials to cure to a semi-set state; and
cutting the laminated slab product into smaller pieces.

20. A method according to claim 19, wherein a photocatalytic agent is added to the slab product mixture prior to pouring of same.

21. A method according to claim 19, further comprising including the laminated product in a sealable container prior to the product fully curing.

22. A method according to claim 21, wherein the sealable container is evacuated of air prior to sealing.

23. A method according to claim 22, wherein gas is inserted into the sealable container subsequent to evacuation of air.

24. A method according to claim 23, wherein the gas is carbon dioxide.

25. A laminated product produced by a process comprising:
placing the substrate onto the slab material when the slab product is in a semi-set state;
cutting the slab product to a desired shape or configuration with a vibrating cutting tool when the slab product is in a semi-set state; and
allowing the laminated product to cure.

26. A method according to claim 1, wherein a photocatalytic agent is added to the slab product mixture.

27. A method according to claim 1, further comprising including the laminated product in a sealable container prior to the product fully curing.

28. A method according to claim 27, wherein the sealable container is evacuated of air prior to sealing.

29. A method according to claim 28, wherein gas is inserted into the sealable container subsequent to evacuation of air.

30. A method according to claim 29, wherein the gas is carbon dioxide.
